(19) United States
(12) Patent Application Publication
(10) Pub. No.: US 2016/0178528 A1
(43) Pub. Date: Jun. 23, 2016

(54) DEVICES FOR DETECTING CONTAMINATION IN COATINGS

(71) Applicant: Agiltron, Inc., Woburn, MA (US)

(72) Inventors: Wayne A. Weimer, Andover, MA (US); Guanghai Jin, Chelmsford, MA (US)

(21) Appl. No.: 14/578,048

(22) Filed: Dec. 19, 2014

(51) Int. Cl. G01N 21/84; G01N 21/94; G01N 21/55

(52) U.S. Cl. CPC G01N 21/8422; G01N 21/55; G01N 21/94; G01N 2021/8427

(57) ABSTRACT

A device disclosed herein includes an optical detector that detects a specular reflection from a test article having a coating thereon. The device also includes a processor operatively coupled to the optical detector and configured to determine whether a contaminant is present at the coating based on the specular reflection and based on a calibration measurement determined from a test article having a known contaminant-free sample of the coating thereon. Another device disclosed herein includes an optical detector that detects a specular reflection from the test article having a coating thereon, with the specular reflection at an angle of less than 20° with respect to an axis normal to the test article. The device can further include a processor configured to determine whether contamination is present at the coating. Embodiments enable rapid, sensitive testing of epoxy and paint surfaces by minimally trained personnel.

### GOVERNMENT SUPPORT

This invention was made with government support under Contract No. N00024-12-NR-52433 from the U.S. Navy. The government has certain rights in the invention.

### BACKGROUND

When contamination is present on surfaces that are coated with paint or epoxy, the contamination can compromise the integrity of the coating. In particular, water vessels such as submarines and ships and other structures exposed to marine environments can be particularly susceptible to a compromised coating. One such contaminant, amine bloom, can form when an epoxy paint is applied to a surface under adverse environmental conditions, for example.

One existing method to detect contamination in epoxy coatings includes visually inspecting test papers that have gone through a chemical preparation process and have been allowed to dry. Light beams have also been used to analyze painted surfaces by detecting specular reflections from the surface, with the specular reflections being in a direction more than 20° away from an axis normal to the painted surface. These analyzers measure surface gloss of the coated surface.

### SUMMARY

Analyzing coated surfaces to test for contamination more rapidly than can be accomplished using chemically prepared test papers, for example, would be useful. In the case of light-based testing for contamination, detecting light that is specularly reflected from a test surface along an axis nearly normal to the test surface would be beneficial for increasing sensitivity of the detection and for increasing probe depth in the coating. Furthermore, it would be useful to measure paint film quality, not just a surface reflection, where surface reflection simply measures gloss of the surface.

In accordance with embodiments described herein, rapid, sensitive, and accurate detection and identification of the quality of a cured coating, such as paint or epoxy, can be performed. A paint curing process, for example, can be monitored in essentially real-time. Embodiment systems can make use of measurements in which incident light and detected light paths share a common optical axis or have optical axes with less than 20° separation from an axis normal to the test surface. This configuration can increase sensitivity of contamination detection by maximizing penetration of light past an outer surface of a coating and into the coating itself to detect contamination in the coating. Accordingly, embodiments can be used to measure paint film quality sensitively and accurately. Analyzer devices can be automated and used by minimally trained personnel for rapid detection of contaminants.

An embodiment device can include an optical detector configured to detect a specular reflection from a test article having a coating thereon. The device can also include a processor operatively coupled to the optical detector and configured to determine whether a contaminant is present at the coating based on the specular reflection and also based on a calibration measurement determined from a calibration article having a known contaminant-free sample of the coating thereon.

The coating can be an epoxy coating or a paint coating. The contaminant can be amine bloom, silicone oil, vacuum pump oil, or another contaminant. The optical detector and the processor can form part of a handheld device. The processor can be configured to determine whether the contaminant is present in the coating. The calibration measurement determined from the calibration article can be obtained environmentally proximal to the specular reflection from the test article. The specular reflection can be a near infrared (IR) reflection, a mid-IR reflection, or a visible reflection.

The device can also include a light emitting diode (LED) or laser source configured to output a collimated beam, and the specular reflection from the surface is a reflection of the collimated beam. The specular reflection from the test article can be at an angle of less than 20° with respect to an axis normal to the test article. Furthermore, the specular reflection can be substantially collinear with the axis normal to the test article. The processor can be configured to use the calibration measurement to correct for an effect of temperature or humidity. Test articles can include a boat, ship, submarine, bridge, oil well, oil platform, or other surface having the coating thereon.

In another embodiment, a device can include an optical detector configured to detect a specular reflection from a test article having a coating thereon. The specular reflection can be at an angle of less than 20° with respect to an axis normal to the test article. The device can also include a processor configured to determine whether contamination is present at the coating based on the specular reflection.

The specular reflection can be substantially collinear with the axis normal to the test article. The processor can be further configured to determine whether the contamination is present based further on the calibration measurement determined from a calibration article having a known contaminant-free sample of the coating thereon. The device can also include a device housing configured to hold the optical detector and processor, the housing further configured to be held in a human hand. The device can further include an LED or laser source configured to output a collimated beam, and the specular reflection from the test article can be a reflection of the collimated beam.

In a further embodiment, a contamination tester can include a housing with a front housing surface configured to be placed substantially parallel and proximal to a contamination test surface. The tester can also include a flexible gasket surrounding an optical port on the front housing surface, as well as three or more substantially rigid contact pads on the front housing surface. The contact pads can be configured to come into contact with the test surface to register the front housing surface substantially parallel to the test surface, with the flexible gasket forming a light-restrictive seal with the test surface.

The contamination tester can also include a contact switch configured to change its switch state as the contact pads are brought into and out of contact with the test surface, a switch ON state arming or activating the contamination tester and a switch OFF state disarming or inactivating the contamination tester. The contact switch can be configured to arm the contamination tester to enable a trigger switch to trigger a contamination measurement of the test surface. The flexible gasket can be configured to flex as the gasket is pushed against the test surface to allow the contact pads to come into contact with the test surface. The flexible gasket can protrude a first distance from the front housing surface when not contacting the test surface, the contact pads can protrude a second distance from the front housing surface, where the second distance is less than the first distance, and the contact switch can protrude a third distance from the front housing surface, the third distance being between the first and second distances.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1A is a block diagram illustrating an embodiment device including an optical detector and a processor.

FIG. 1B illustrates a calibration article with a known contaminant-free sample of the coating that can be used to calibrate the device of FIG. 1A.

FIG. 1C is a flow diagram illustrating an example process for determining whether a contaminant is present at the coating of a test article.

FIGS. 2A-2B are top-view and perspective-view illustrations, respectively, of an optical assembly forming part of an embodiment handheld contamination tester.

FIGS. 2C-2E are side-view, front-perspective-view, and rear-perspective-view illustrations of the embodiment handheld tester, for which the optical assembly is illustrated in FIGS. 2A-2B.

FIG. 2F is a photograph showing one type of usage of the handheld tester of FIGS. 2C-2E.

FIG. 2G is a series of photographs of a user display of the handheld tester of FIGS. 2C-2E at various phases of operation of the tester.

FIG. 2H is a schematic block diagram of some electrical components in the tester of FIGS. 2C-2E.

FIG. 3 is an illustration of an alternative design for a gasket, contact pads, and a contact switch used in the handheld tester of FIGS. 2C-2E.

FIG. 4 illustrates a submarine test article that can be tested using the handheld tester illustrated in FIGS. 2C-2E.

FIG. 5A is a schematic illustration of a test apparatus used to show feasibility of embodiment devices and methods for detecting contamination.

FIG. 5B is a photograph showing test samples of epoxy coating prepared under adverse curing conditions.

FIG. 5C is a photograph of test samples similar to those of FIG. 5B but prepared under normal epoxy curing conditions.

FIG. 5D is a graph illustrating reflected laser power measurements for various test samples illustrated in FIGS. 5B-5C.

FIG. 5E is a bar chart illustrating reflected intensity maximum for each of the samples for which test results are shown in FIG. 5D.

FIGS. 5F-5G are graphs illustrating the effect of exposure time to adverse curing conditions on reflectance measurements used to detect amine bloom contamination.

FIG. 5H is a bar chart illustrating reflectance measurement results for samples provided by the U.S. Navy.

### DETAILED DESCRIPTION OF THE INVENTION

A description of example embodiments of the invention follows.

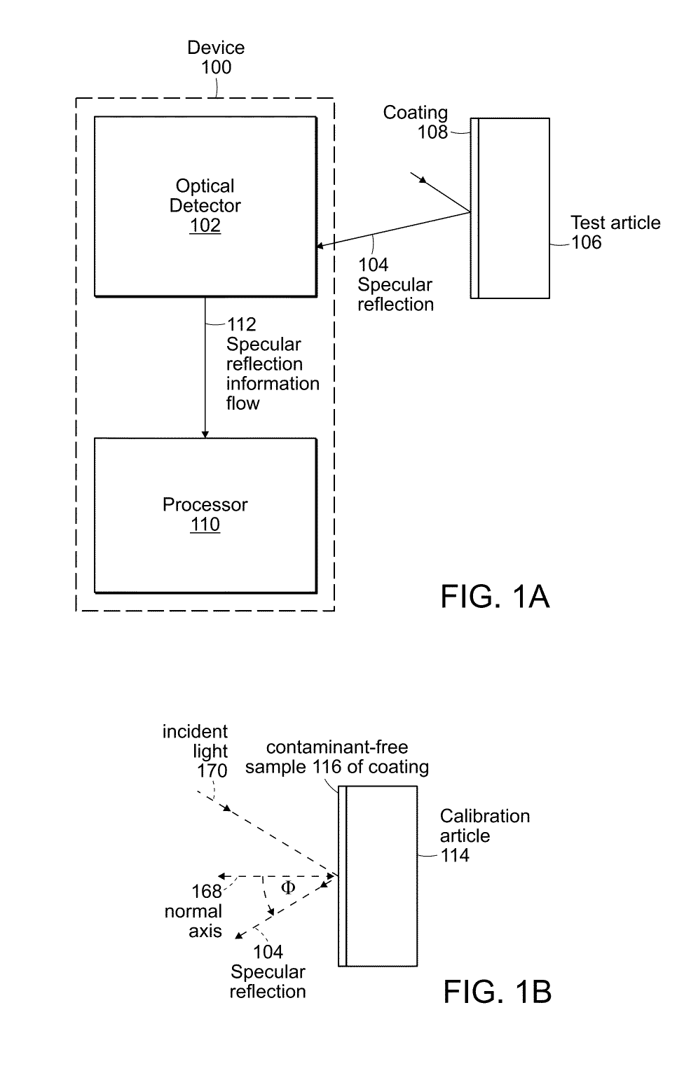

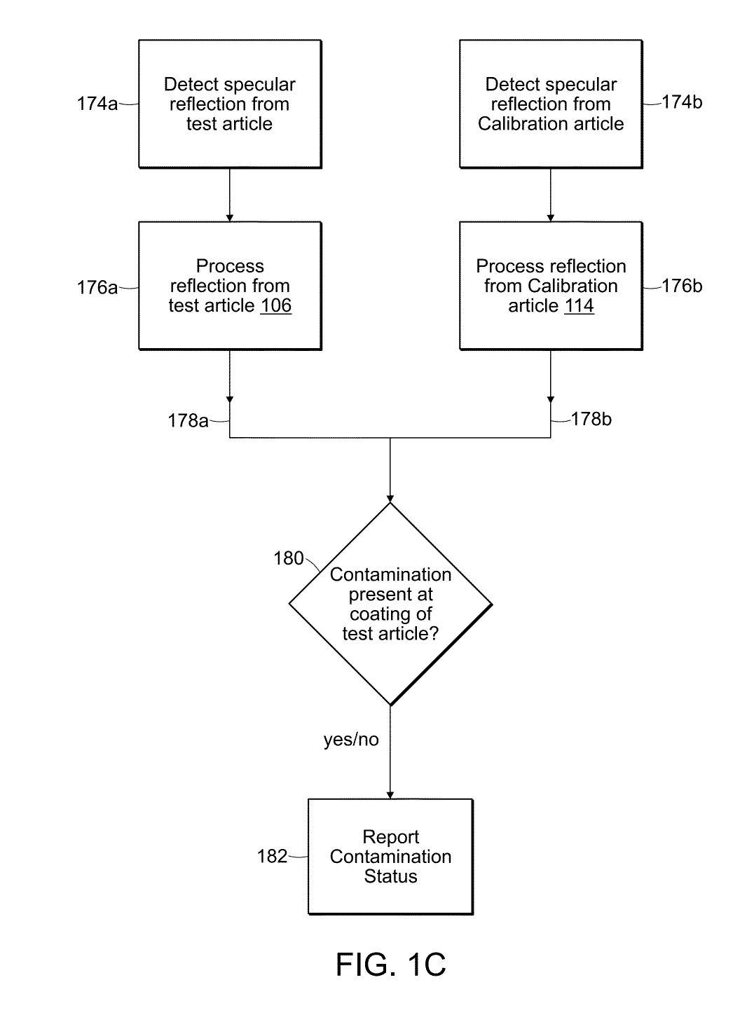

FIG. 1A is a block diagram illustrating an embodiment device 100. The device 100 includes an optical detector 102 configured to detect a specular reflection 104 from a test article 106 having a coating 108 thereon. The device also includes a processor 110 operatively coupled to the optical detector 102 and configured to determine whether a contaminant is present at the coating 108 based on the specular reflection 104.

Testing by embodiment devices for contamination of the coated surface can include testing for contamination on the surface or in the surface. The coating 108 can be an epoxy coating, and a contaminant at the coating 108, for which the processor 110 tests, can include amine bloom. However, the coating 108 is a paint coating or another type of coating applied to a surface of the test article 106. Furthermore, the optical detector 102 can be configured to detect the specular reflection 104 of incident light 170 from the test article 106 in cases where the coating 108 can be contaminated with other contaminants, and the processor 110 can be configured to determine whether another contaminant is present at the coating 108. Other contaminants besides amine bloom can include silicone oil or vacuum pump oil, for example.

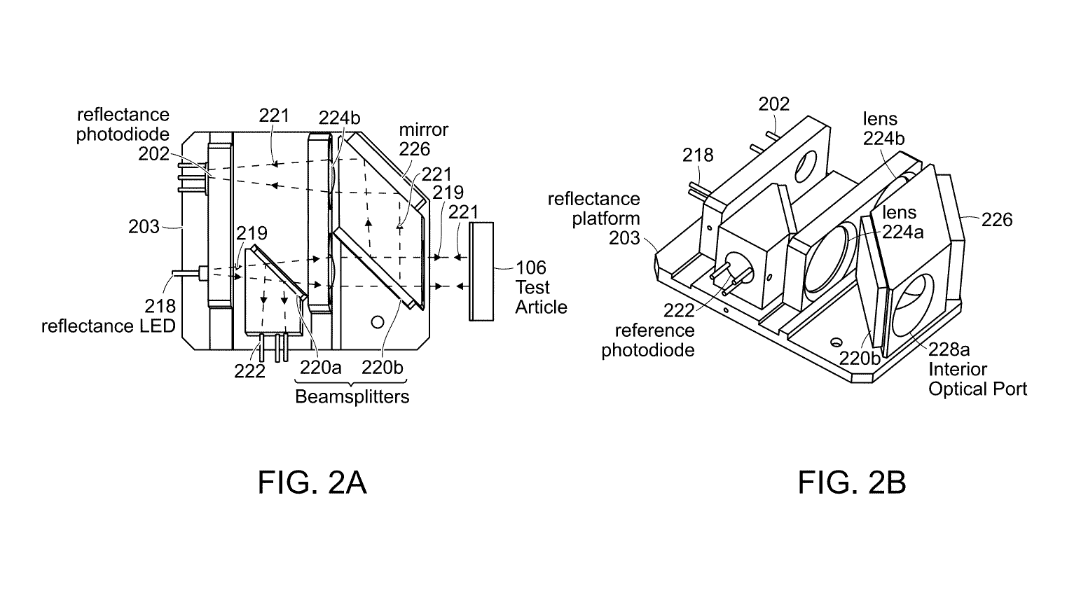

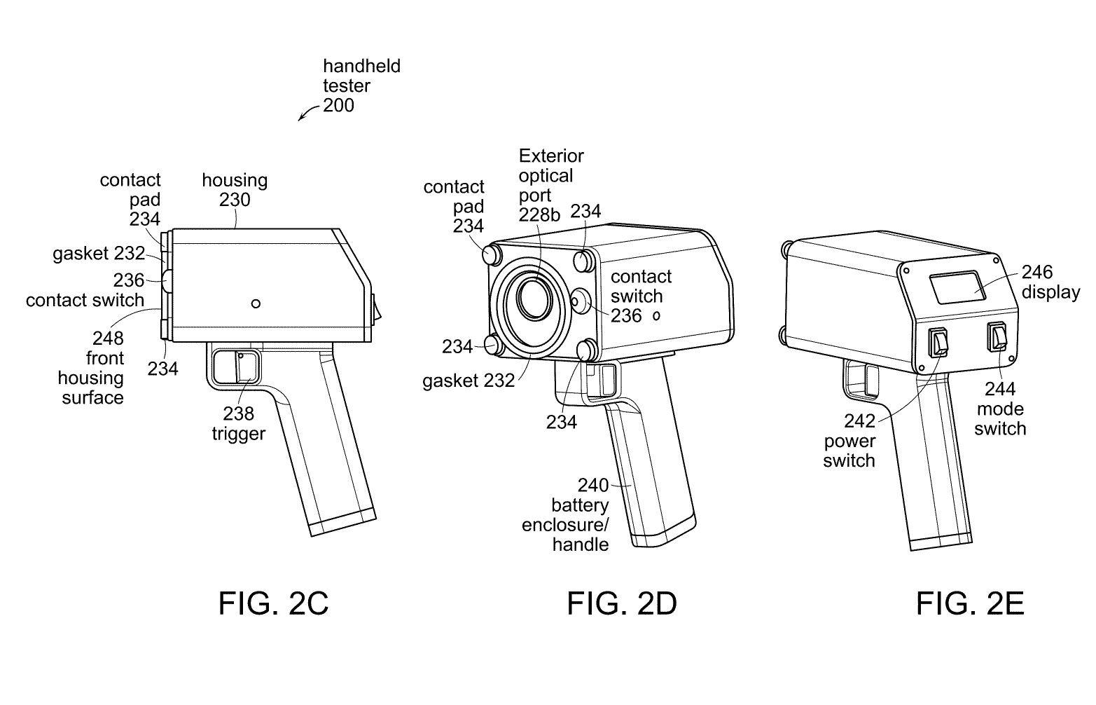

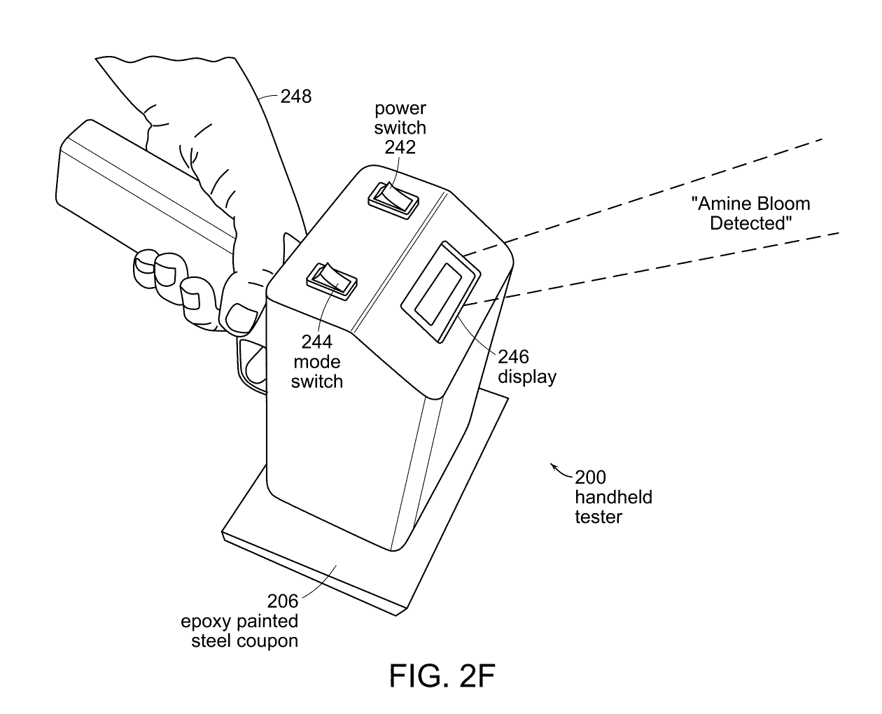

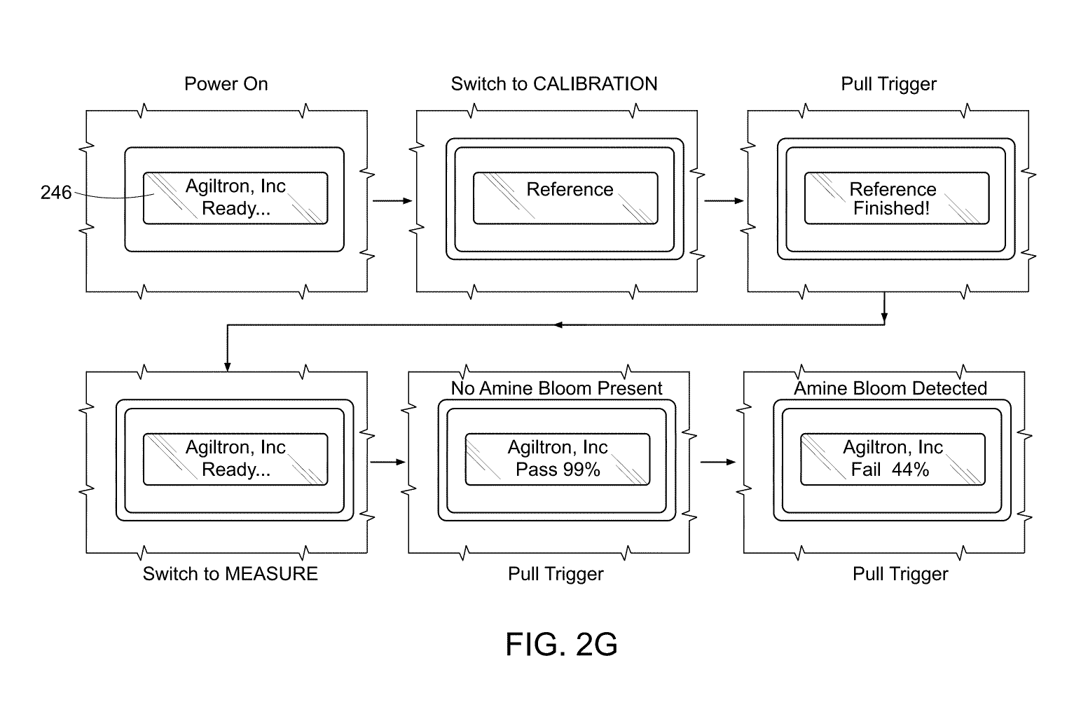

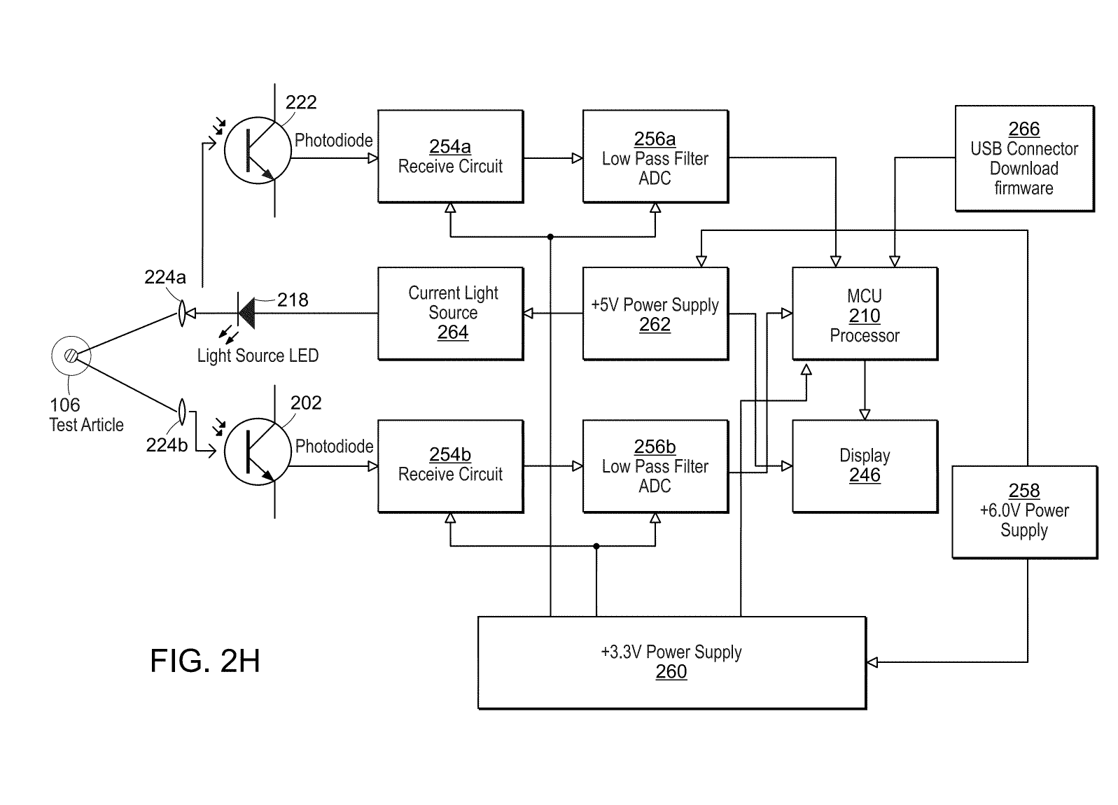

In some embodiments, the optical detector 102 and processor 110 can form part of a handheld device. One such handheld device is illustrated in FIGS. 2A-2H, for example, which are described hereinafter. However, in other embodiments, the optical detector and processor are separated by a greater distance. For example, the detector can be part of a handheld module that transmits data to a remote computer with a processor performing detection calculations. Operative coupling between the detector 102 and processor 110 can be via wired or wireless communications, for example. The specular reflection 104 can be a specular reflection of near infrared (IR) light incident at the coating 108 on the test article 106. In other embodiments, however, the specular reflection is a mid-IR or visible reflection.

FIG. 1B illustrates a calibration article 114 with a known contaminant-free sample 116 of the coating 108. The sample 116 of the coating can be used to calibrate the device 100. Thus, the processor 110 in FIG. 1A can be configured to determine whether the contaminant is present at the coating 108 of the test article 106 based not only on the specular reflection 104, but also on a calibration measurement determined from the calibration article 114 having the contaminant-free sample 116.

FIG. 1B also illustrates a normal axis 168 that is normal to the tested surface of the calibration article 114. Incident light 170 is incident at the surface, and the specular reflection 104 is at an angle Φ with respect to the normal axis 168. In some embodiments of the device 100 in FIG. 1A, the specular reflection from the calibration article 114 or the test article 106 is at an angle of less than 20° with respect to the axis 168 normal to the test article or calibration article. Furthermore, in some embodiments, the specular reflection 104 is substantially collinear with the axis 168 normal to the test article or calibration article. As used herein, “substantially collinear” indicates an angle Φ within a range of about ±5°. An advantage of the immediately foregoing embodiment is that effects of curvature of the test article or calibration article are removed from a measurement to a substantial extent, such as 90%, 95%, or 100% relative to an embodiment in which a larger angle Φ is used. A further advantage of configuring the specular reflection to be substantially collinear to the test article is that the incident light 170 is then also nearly normal. This maximizes penetration of light into the coating and allows the coating to be sensitively tested for contaminants in the coating as well as on the coating. This is in contrast to larger angles Φ (e.g., Φ≧20°), which result in essentially 100% of specularly reflected light being reflected at the outer surface of the coating.

FIG. IC is a flow diagram illustrating an example process for determining whether a contaminant is present at the coating of the test article. Devices, such as the device 100 in FIG. 1A, for example, can be configured to perform the procedure illustrated in FIG. 1C. At 174a, a specular reflection from a test article is detected by the optical detector 102. At 176a, the detected reflection is processed. The processing at 176a can include analog-to-digital (A/D) conversion at the optical detector 102 or at a circuit external from the optical detector 102 (not shown in FIG. 1A). As one alternative, the processing can include analog signal conditioning performed at the optical detector 102 or an external circuit. Furthermore, the processing 176a can also include digital signal conditioning and/or application of a calibration factor to the detected specular reflection measurement, and these operations can be performed by the processor 110, for example. At 178a, processed reflection information flows to 180. At 180, the processor 110 determines whether contamination is present at the coating of the test article. At 182, the contamination status is optionally reported, and the reporting can be via a display, such as the one illustrated in FIG. 2E, for example, or by any other means such as light indicators, sound indicators, data reports, etc.

FIG. 1C also illustrates, at 174b, detection of a specular reflection from a calibration article. In FIG. 1C, the reflection from the calibration article is processed at 176b in the same way that the reflection from the test article is processed at 176a. Information 178b regarding the processed reflection from the calibration article is obtained by the processor 110, which determines whether contamination is present at the coating of the test article based on the calibration measurement determined from the calibration article, which has a known contaminant-free sample of the coating thereon, as well as based on the specular reflection from the test article. In some embodiments, the specular reflection from the calibration article is detected first, then processed, and then sent to the processor 110, followed by detection of the specular reflection from the test article, followed by reporting a corrected contamination test measurement. In other embodiments, the specular reflection from the test article is first detected, followed by detection of the specular reflection from the calibration article. Furthermore, in yet other embodiments, the specular reflections from the test article and calibration article can be detected simultaneously using respective optical detectors. There are no exact timing requirements between the detections at 174a and 174b. However, it can be advantageous to determine the calibration measurement from the calibration article environmentally proximal to detecting the specular reflection from the test article. “Environmentally proximal,” as used herein, denotes a proximity in time and/or space between detection of the specular reflection from the test article and determination of the calibration measurement from the calibration article, such that an environmental condition such as temperature or humidity or any other condition affecting relevance of a calibration measurement remains substantially unchanged between the time that the specular reflection from the test article is detected and the time that the calibration measurement is obtained from the calibration article. In this way, the environment of calibration of the device 100 and the environment of detection from the test article are substantially the same, making the calibration as correct as possible. The processor 110 in FIG. 1A can be configured to use the calibration measurement obtained at 174b in FIG. 1C to correct for an effect of temperature or humidity or another environmental factor.

FIGS. 2A-2H are illustrations of parts of a handheld contamination detector. These figures illustrate how, in one embodiment, the optical detector 102 and processor 110 in FIG. 1A can form part of a handheld device. The device of FIGS. 2A-2H is designed to detect and amine bloom, but other embodiments can be configured to detect another contaminant or multiple contaminants.

FIGS. 2A-2B are top-view and perspective-view illustrations, respectively, of a reflectance-based optical assembly mounted on a reflectance platform 203 to form part of the handheld amine bloom detector. The handheld detector is designed to be placed in contact with a test article such as the hull of a ship or submarine coated with an epoxy-based coating. The design of FIGS. 2A-2B utilizes an 850 nm reflectance LED 218 to provide the light source to the specularly reflected from the test article 106, and the specular reflection is detected by a reflectance photodiode optical detector 202.

Selection of the LED wavelength 850 nm avoids absorption bands for this amine bloom/epoxy application, thus helping to ensure that the measured reflected intensity is an accurate indication of the quality of the examined surface and free of interfering optical factors. In other embodiments, different wavelengths may be used depending on the corresponding absorption bands for a given coating or contaminant. It should be pointed out that near-IR wavelengths, such as 850 nm and 785 nm, for example, have the advantage of avoiding absorption bands for epoxy coating applications with amine bloom and also many organic contaminants such as silicone oil and vacuum pump oil.

Still referring to FIGS. 2A-2B, the light beam 219 from the LED 218 passes through a beam splitter 220a that reflects a portion of the beam to a reference photodiode 222 that monitors the output of the LED 218. The remainder of the beam 219 passes through the beam splitter 220a to a collimating lens 224a that collimates the beam. The collimated beam passes through a 50-50 beam splitter 220b and exits through an interior optical port 228a of the optical assembly to illuminate the surface of the test article 106. A specular reflection 221 from the test article passes to the 50-50 beam splitter 220b, which reflects half of the light from the specular reflection 221 at 90° toward a mirror 226. The mirror 226 then reflects the beam 221 toward a focusing lens 224b, which focuses the beam 221 onto the reflectance photodiode optical detector 202. This optical arrangement ensures that essentially only specularly reflected light from the test article 106 reaches the detector. As described further hereinafter, laboratory test results show conclusively that the intensity of specularly reflected light is most effective in detecting amine bloom. The design illustrated in FIGS. 2A-2B has no moving parts, so optical alignment of the device can be maintained optimally despite the relatively harsh usage conditions expected in an industrial environment, such as a shipyard.

The handheld amine bloom sensor is designed to be battery-powered. Based upon the intensity of the specular reflection 221 compared with an internal reference obtained using the reference photodiode 222, the device determines whether or not the test surface is contaminated with amine bloom. As soon as the measurement is made, a message appears in an LED display illustrated in FIGS. 2F-2G to inform the user of the analysis result. Measurement times for the device can be short, allowing the result to be obtained in only 1 or 2 seconds.

In other embodiments, a laser light source can be used instead of an LED. However, in many reflectance-based contamination measurement applications, the light used for detection need not be extremely narrowband, and an LED is sufficient.

FIGS. 2C-2E illustrates side-view, front-perspective-view, and rear-perspective-view illustrations of the handheld tester 200. The optical assembly illustrated in FIGS. 2A-2B is held within a housing 230, together with a processor and other electronics illustrated in FIG. 2H. A front housing surface 248 of the house 230 has several components mounted thereon, including a flexible gasket 232, four contact pads 234, and a contact switch 236. In use, when the tester 200 is lightly pressed against the test article, the gasket 232 flexes against the test article and forms a light-restrictive seal that excludes all or most of the environmental light incident at the front housing surface 248 of the tester 200. Furthermore, as the tester 200 is lightly pressed against the surface of the test article, the contact switched 236 is actuated, thereby arming (activating) the tester to emit light from the reflectance LED 218 if a trigger 238 is pulled. The contact pads 234 ensure even registration of the front housing surface 248 against the test article. Thus, the contact pads 234 help to ensure that the front housing surface 248 is registered substantially parallel to the coated surface of the test article 106. While four contact pads used for the tester 200, the other embodiments include only three pads to define contact plane. “Substantially parallel,” as used herein, indicates that the front housing surface 248 is parallel to the coated surface of the test article 106 to within ±5°. Furthermore, where a coated surface of a test article is nonplanar, “substantially parallel” indicates that a normal axis (not shown) that is perpendicular to the front housing surface 248 is parallel to a normal axis of the test article, similar to the normal axis 168 illustrated in FIG. 1B, to within about ±5°. The optical assembly of FIGS. 2A-2B is further configured such that both the collimated beam 219 and the specular reflection 221 are substantially collinear to each other and to an axis normal to the test article 106 when the front housing surface 248 is substantially parallel to the coated surface of the test article.

FIGS. 2C-2E also illustrate that the handheld tester 200 includes an exterior optical port 228b, which is surrounded by the gasket 232, through which light is emitted from the reflectance LED 218 to the test article 106 and specularly reflected by the test article 106 back into the tester 200. A handle 240 of the tester is designed to be grasped by a human hand as illustrated in FIG. 2F, and the handle 240 also serves as a battery enclosure for the battery-powered handheld tester 200.

The contact switch 236 is configured to change its state as the contact pads 234 are brought into and out of contact with the test surface (coated surface of the test article). A switch ON state arms or activates the contamination tester, while a switch OFF state disarms or inactivates the contamination tester. In particular, when the contact switch 236 is in the switch ON state, the tester 200 is enabled to obtain a contamination measurement of the test surface of the test article when the trigger switch 238 is pulled.

A calibration or contamination measurement is initiated by pulling the trigger 238 on the handle 240. The tester 200 emits light to the test article only if both the contact switch 236 is actuated and the user pulls the trigger 238. This safety feature ensures that the instrument cannot produce light unless it is in contact with the test surface, where the gasket will confine all emitted light to the coated surface area to be analyzed.

FIG. 2E also illustrates that the tester 200 includes a power switch 242 to turn the tester on or off. The tester 200 also includes a mode switch 244, which sets the tester to acquire a reflectance measurement either from a calibration article or from the test article. A display 246 indicates tester status and contamination pass/fail information, as illustrated in FIG. 2G.

FIG. 2F is a photograph of the handheld tester 200 being held by a human hand 248 against an epoxy painted steel coupon test article 206. The test article 206 is coated with an amine bloom epoxy paint sample supplied by the U.S. Navy, as described further hereinafter. The photonic amine bloom sensor tester 200 is powered by four AA batteries (not shown) and is simple to operate, requiring only very minimal training. The display 246 of the handheld tester can be configured to display “Amine Bloom Detected” or a similar phrase, for example, when a test indicates the presence of amine bloom.

FIG. 2G is a series of photographs of the display 246 during various phases of operation of the tester 200. Arrows indicate the sequence of the various phases of operation. After turning on the tester using the power switch 242, the display 246 indicates “ready.” The mode switch 244 is switched to the calibration position, and the sensor display then reads “reference.” At this point, the sensor is ready to measure a calibration sample, and the result is stored for comparison to subsequent measurements. The calibration sample is obtained using an epoxy painted calibration sample that is free of amine bloom. As previously described hereinabove, the tester 200 is lightly pressed against the reference sample and the calibration result is measured and stored when the trigger 238 is pulled. After calibrating the sensor, the mode switch 244 is set to the measure position, and the display 246 reads “ready.” The tester 200 is then ready to analyze test articles (samples).

To make a measurement, the tester 200 is brought into contact with the sample surface, and the trigger 238 is pulled, just as when the calibration sample is measured. Within one second of pulling the trigger 238, the LCD display 246 reads either “pass” or “fail” and a percentage is displayed. The displayed percentage is the ratio of the power measured at the reflectance photodiode 202 for the test article and the power measured at the reflectance photodiode 224 for the calibration article, expressed as a percentage. A sample yielding a passing result (high percentage) is considered to be free of amine bloom, while a failing sample (low percentage) is considered to be contaminated with amine bloom. The pass/fail percentage threshold can be set according to a particular user's criteria for paint quality.

FIG. 2H is a schematic block diagram of some electrical components in the tester 200. The light source (reflectance) LED 218 is configured to illuminate the test article 106, as described hereinabove in conjunction with FIGS. 2A and 2B. A portion of the light from LED 218 is reflected onto the reference photodiode 222 as a check of the output power and functional status of the LED 218. Signals obtained by the photodiode 222 are processed and conditioned at a received circuit 254a, and the processed signals from the received circuit are low-pass filtered and converted to digital signals at a low-pass filter/analog-to-digital converter (ADC) 256a. The converted digital signals are sent to a microcontroller (MCU) processor 210.

Most of the light from the LED 218 is collimated by the collimating lens 224a and directed onto the test article 106. A specular reflection from the test article 106 is focused by the focusing lens 224b onto the reflectance photodiode 202. Signals from the photodiode 202 are processed at a receive circuit 254b and then filtered and converted to digital signals at a low-pass filter/ADC 256b. The digitally converted signals from filter/ADC 256b are then sent to the MCU processor 210. The processor 210 then determines whether amine bloom contamination is present at the coated surface of the test article 106.

The schematic block diagram in FIG. 2H also includes several other elements. A positive 6V power supply at 258 (four AA batteries held in the battery enclosure/handle 240 illustrated in FIG. 2D) supplies the tester 200. The power supply 258 powers a +3.3 V power supply 260 configured to supply power to the receive circuit 254b, low-pass filter/ADC circuit 256b, and MCU processor 210. The power supply 258 also supplies a +5 V power supply 262, which in turn drives an LED current source 264 and the display 246, which displays the pass/fail results provided by the MCU processor 210, as further illustrated in FIG. 2G. The tester also includes a USB port connector 266, which can be used to download firmware to the MCU 210.

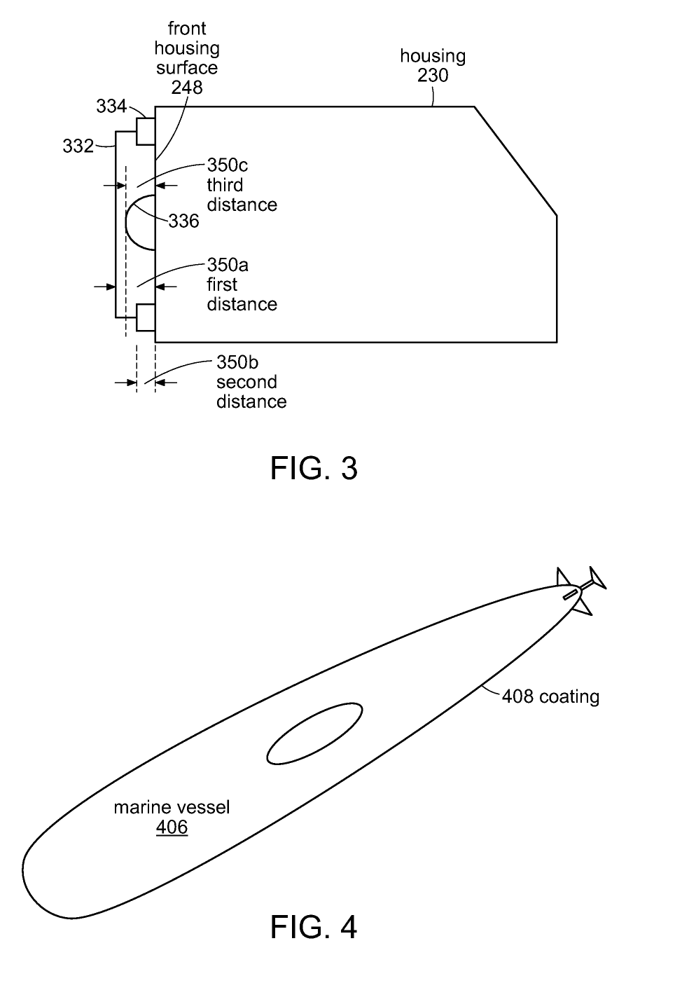

FIG. 3 is an illustration of an alternative design for a gasket 332, contact pads 334, and contact switch 336. The design of FIG. 3 includes the housing 230 having the front housing surface 248, as illustrated in FIG. 2C. However, the design of FIG. 3 includes particular dimensions for the gasket 232, contact pads 234, and contact switch 236 that further facilitate blocking ambient light, registering the tester front housing surface substantially parallel to the test surface, and actuating the contacts switch 236 as desired. In particular, the flexible gasket 332 protrudes a first distance 358 from the front housing surface 248 when not in contact with the test article. The contact pads 334, in contrast, protrude a second distance 350b from the front housing surface 248, where the distance 350b is smaller than the distance 350a. The contact switch 336 protrudes a third distance 350c from the front housing surface 248, and the distance 350c is between the distances 350a and 350b.

The design of FIG. 3 facilitates testing and calibration as follows. The flexible gasket 332 is configured to flex as the gasket is pushed against the test surface to allow the contact pads 334, which are substantially rigid, to come into contact with the test surface. Thus, the gasket 332 forms a tight, light-restrictive seal around the exterior optical port 228b (illustrated in FIG. 2D). Furthermore, because the contact pads 334 are substantially rigid, pushing the tester against the test surface until the gasket 332 flexes sufficiently so that all contact pads 334 are in contact with the test surface registers the front housing surface substantially parallel to the test surface. The contact switch 336 is configured to change its switch state as the contact pads are brought into and out of contact with the test surface. A switch ON state arms or activates the contamination tester, and a switch OFF state disarms or inactivates the contamination tester. This configuration helps ensure that the light-restrictive seal 332 is secured against the test surface before light is emitted through the exterior optical port.

With the contact pads 334 touching the coated surface of the test article, the front housing surface 248 is also substantially proximal to the test surface. It should be noted that in other embodiments, the front housing surface 248 is substantially proximal to the test surface at greater distances between the test surface and front housing surface 248. Namely, the two surfaces are substantially proximal to each other in circumstances in which light from the reflectance LED 218 can be reliably reflected from the test article 106 and the specular reflection can be received at the reflectance photodiode 202 while maintaining signal integrity and signal levels sufficient for the application and while maintaining the front housing surface substantially parallel to the test surface.

FIG. 4 illustrates a submarine test article 406. The submarine 406 has a coated surface 408 that can be tested using the handheld tester 200 illustrated in FIGS. 2A-2H. Other test articles besides submarines can include boats, ships, bridges, oil wells, or oil platforms with coated surfaces, for example. Furthermore, the handheld tester 200 illustrated in FIGS. 2A-2H can also be configured to test many other test articles that have coatings such as an epoxy coating or paint coating.

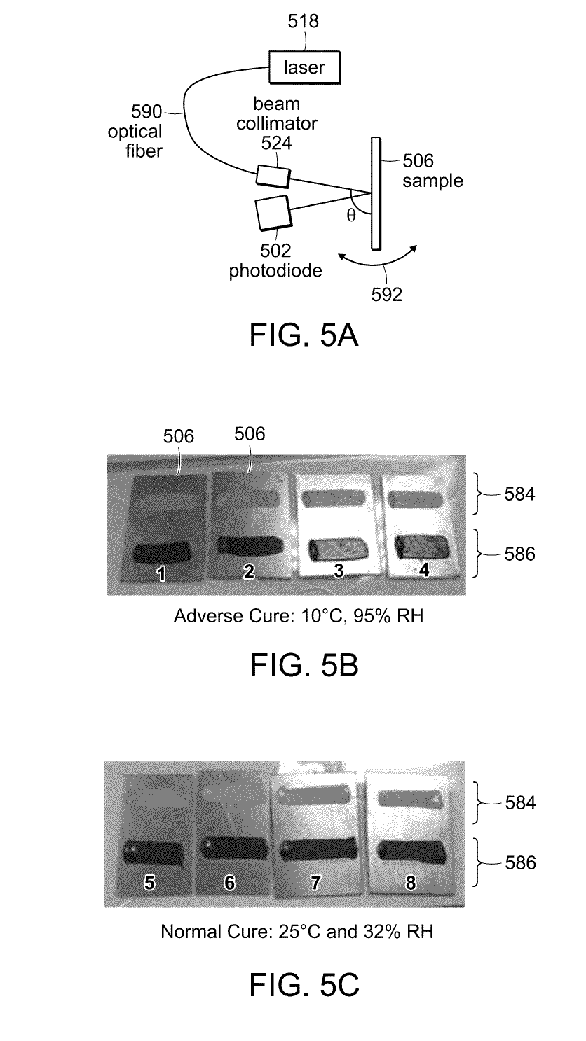

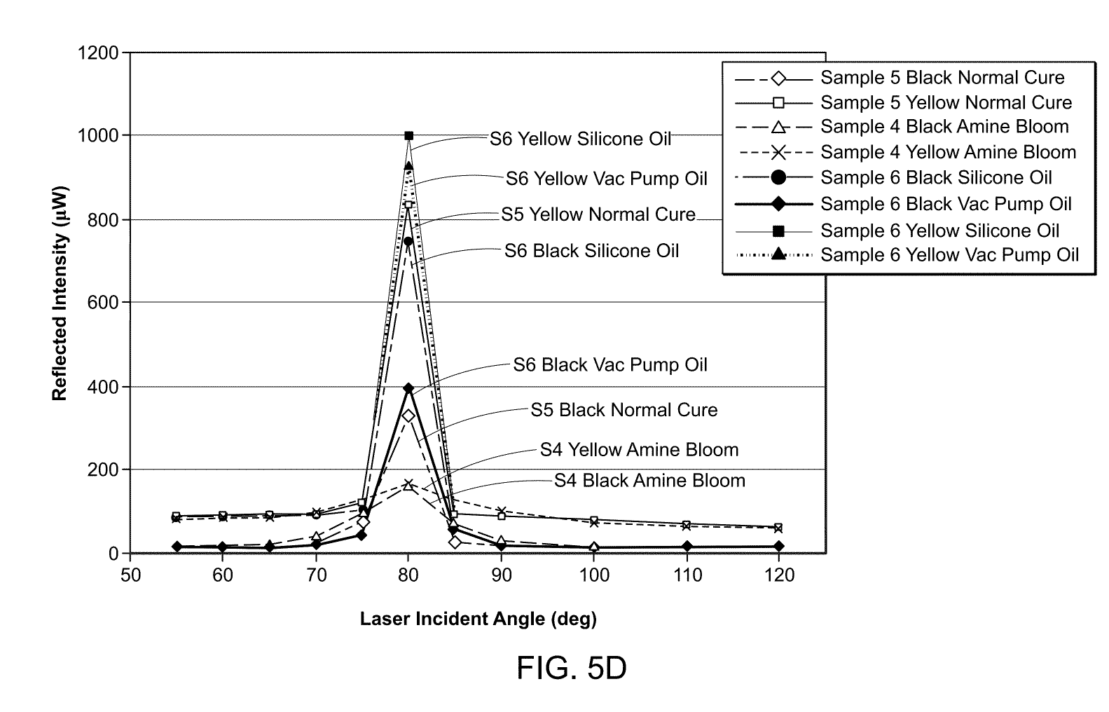

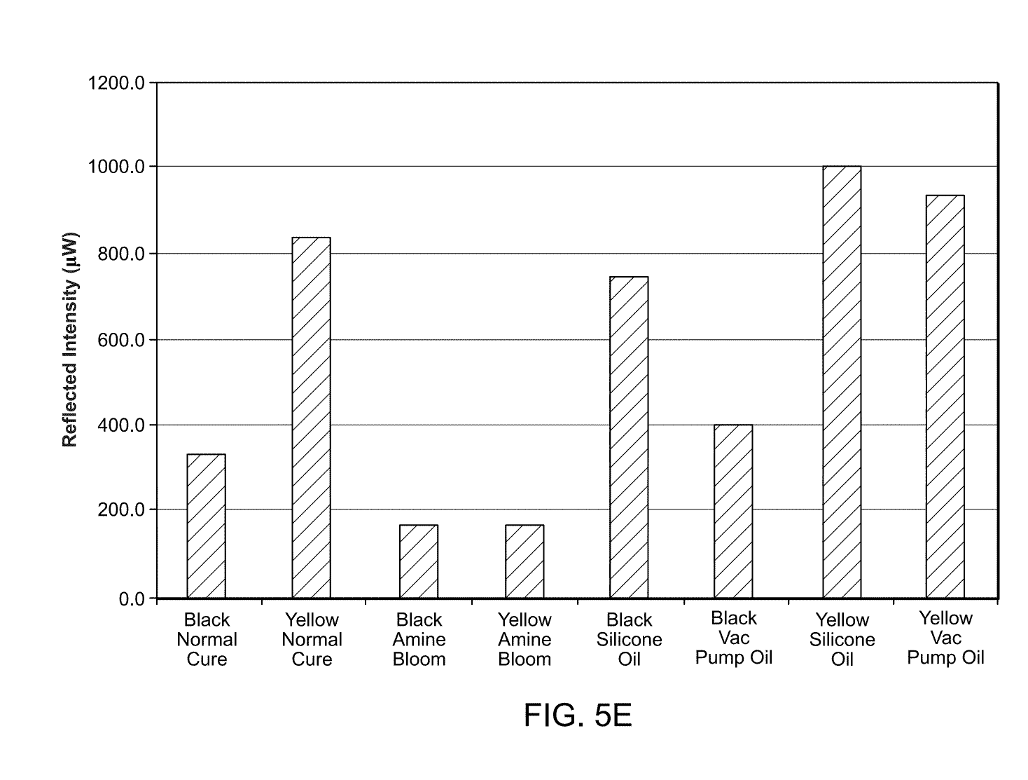

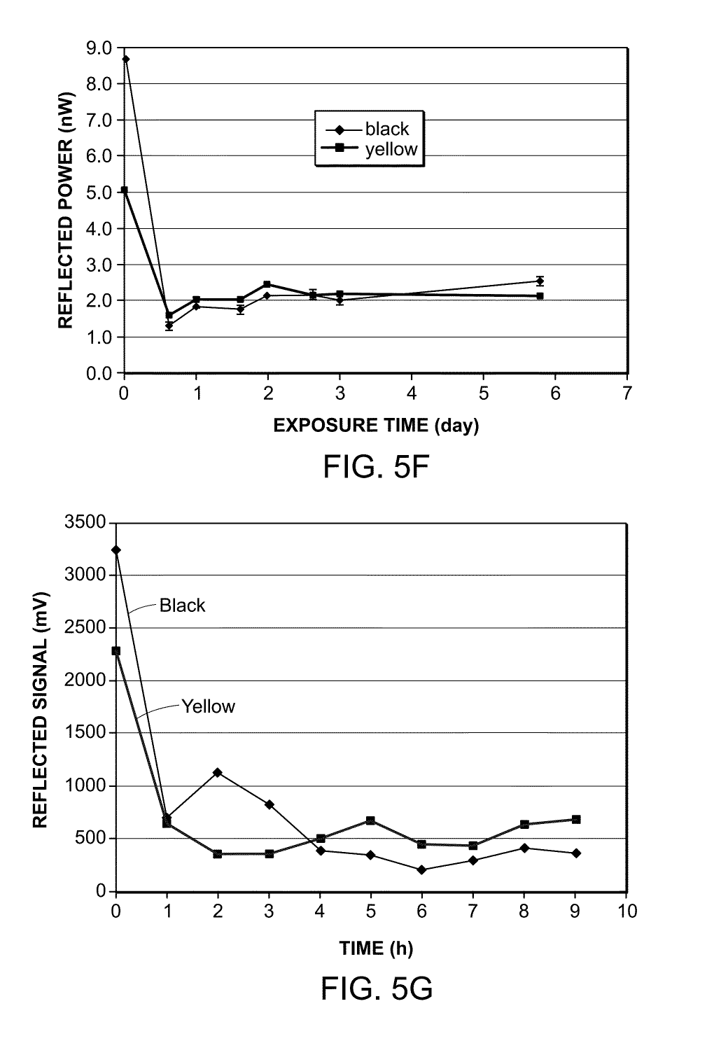

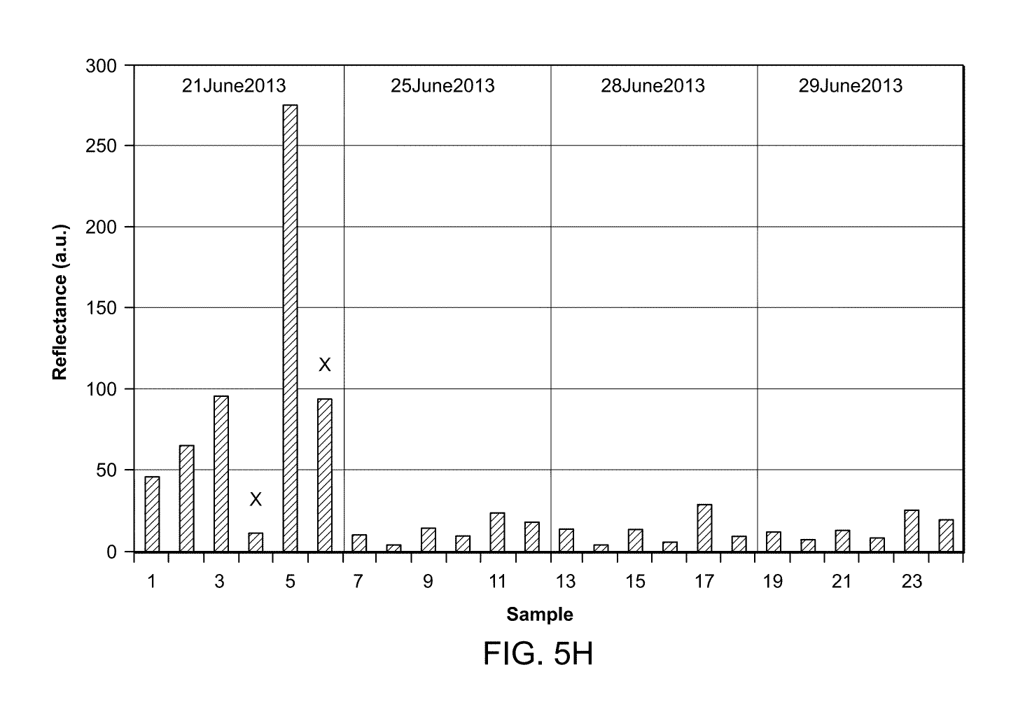

FIG. 5A is a schematic illustration of a test apparatus that was built during the development of the handheld tester 200 illustrated in FIGS. 2A-2H. The apparatus of FIG. 5A was built to measure laser light reflected from painted steel samples. A laser 518 light source was used, and an optical fiber 590 coupled light from the laser 518 to a beam collimator 524, from which collimated light was emitted toward painted steel samples 506. Light specularly reflected from the painted steel samples 506 was detected by photodiode 502. To examine the effect of incident laser beam angle θ, a sample holder was used. The sample holder (not shown) allowed the laser and detector alignment to remain fixed while the angle of the sample surface presented to the laser was varied, as indicated by a curved arrow 592. A protractor was attached to the sample 506 to measure the laser incident angle, and the protractor was positioned so that a θ=90° reading corresponded to the laser beam being at normal incidence to the sample 506. The angle between the laser beam axis and the photodiode detector optical axis was fixed at 20°, and the system was aligned so that both axes were in the horizontal plane oriented normal to the sample surface. The sample was mounted on a rotatable post (not shown) such that the only measurement parameters varying when the sample was rotated were (i) the angle between the sample surface and the incident laser beam angle and (ii) the angle between the sample surface and the photodiode detector optical axis. Data were collected by iteratively rotating the sample 506 and then recording the sample angle and the reflected laser power measured.

FIGS. 5B-5C illustrate how samples were prepared. Epoxy paint Sherwin-Williams yellow (DTRC 2844-1110) was used for the yellow paint samples 584 in the top rows of FIGS. 5B-5C. In the bottom rows of FIGS. 5B-5C, the epoxy paint Sherwin-Williams black (DTRC 2844-1109) was used to produce the black painted samples 586. The yellow and black epoxy paints were mixed according to the manufacturer's instructions (one part resin to one part hardener) and stirred for 2 minutes to ensure complete mixing. For all samples, a drop of mixed paint was placed on a steel coupon (2″×3″× 1/16″ thick) and then spread with a doctor blade along a line at a thickness of 0.007 inches per the manufacturer's instructions for applied wet thickness. The doctor blade used to apply the paint to the steel components 506 was fabricated by wrapping the three layers of transparent tape 0.5 inches apart around a glass microscope slide. The three tape players insured at 0.007 inch gap between the microscope slide edge and the steel component surface when spreading the paint samples.

Samples 1-4, shown in FIG. 5B, were prepared by spreading the paint onto the steel coupons 506 immediately after the two-minute resin/hardener stirring, thus minimizing induction time. Samples 1-4 were then placed in an environmental chamber set at 10° C. and 95% relative humidity (RH) (adverse cure conditions). Sample 1 was removed from the environmental chamber after one day, sample 2 was removed from the environmental chamber after two days, sample 3 after three days, and sample 4 after four days.

Samples 5-8, shown in FIG. 5C, were prepared and cured properly as per the manufacturer's instructions. For these samples, paint was not spread onto the steel coupons until after allowing 30 min. to pass after the two-minute resin/hardener stirring to allow the appropriate induction time to occur. Samples were then cured properly in laboratory ambient conditions, 25° C. and 32% RH. From the set of samples in FIGS. 5B and 5C, coupons 4, 5, and 6 were selected for measurement and are listed in Table I.

TABLE I
Sample Matrix

| Sample ID | Color | Contamination |
|---|---|---|
| Sample 5 | Black | None |
| Sample 5 | Yellow | None |
| Sample 4 | Black | Amine Bloom |
| Sample 4 | Yellow | Amine Bloom |
| Sample 6 | Black | Silicone Oil |
| Sample 6 | Black | Vacuum Pump Oil |
| Sample 6 | Yellow | Silicone Oil |
| Sample 6 | Yellow | Vacuum Pump Oil |

As described hereinabove, sample coupon 4 was cured for four days in the environmental chamber at low temperature and high RH to promote the formation of amine bloom. Coupons 5 and 6 contained black and yellow epoxy paint stripes that were properly cured. Sample 6, shown in FIG. 5C, was further prepared by dropping one drop (approximately 0.1 mL) of silicone oil and vacuum pump oil near the steel coupon edge on sample 6. The metal coupon was then tilted to 45° to allow the oil drops to flow across both the yellow and black paint stripes. The coupon was then mounted on the optical analyzer illustrated in FIG. 5A, and measurements were made as described above.

FIG. 5D is a graph illustrating reflected laser power measurements for the eight samples listed in Table I as a function of incident laser angle. The laser 518 was operating at 785 nm, and the incident laser angle was varied over the range of 55° to 120°. Selection of the laser wavelength of 785 nm avoids absorption bands for this amine bloom/epoxy application, helping to ensure that the measured reflected intensity is an accurate indication of the quality of the examined surface and free of interfering optical factors. The eight samples measured were selected to represent both black and yellow epoxy paints used by the U.S. Navy that had been prepared to exhibit normal cure, amine bloom contamination, silicone oil contamination, and vacuum pump oil contamination, respectively.

The graph in FIG. 5D shows reflected intensity plotted versus the laser incident angle at the sample surface. All measurements show maximum reflected intensities at 80° incident laser angle, which is due to specular (as opposed to diffuse) reflection. Since the angular separation between the laser beam axis and the photodiode optical axis was fixed at 20°, the photodiode 502 was positioned at an angle corresponding to 70° along the horizontal axis shown in FIG. 5D. Therefore, when the sample 506 was rotated to an angle of exactly half the laser/detector angular separation, the detected reflection was specular. The data of FIG. 5D establish that all 8 samples show significant specular reflection and that differences in the specular reflection can serve as a basis for differentiating between clean and contaminated painted surfaces.

The data shown in FIG. 5D also show that the reflected intensity values for all black paint samples converge to nearly identical values for low and high incident laser angles. The reflected intensities for all yellow samples similarly converged at low and high laser incident angles. Therefore, the informative portion of the reflection from these samples is obtained when the reflected intensities result from specular reflection.

FIG. 5E is a bar chart illustrating reflected intensity maxima for each of the samples listed in Table I, wherein the maxima are the peak reflected intensities shown in FIG. 5D at 80° incident laser angle. As illustrated in FIG. 5E, reflected intensity values are clearly unique for all samples except for the black and yellow amine bloom samples, which are equal. However, the unique value for both of these samples will still allow unambiguous identification of the amine bloom condition on a submarine hull, for example, when compared with the reflected intensities for the black and yellow normal cure cases, respectively.

FIG. 5F is a graph illustrating reflected power measurements performed on seven Sherwin-Williams black (DTRC 2844-1109) and yellow (DTRC 2804-1110) epoxy paint samples. The paint samples were exposed to low temperature (10° C.) and high RH (90%) (adverse curing conditions) for different times following mixing of the resin and hardener. The seven samples were all placed in an environmental chamber with the adverse conditions after mixing according to the manufacturer's directions. The seven samples were removed from the chamber one at a time at approximately ½ day intervals. The goal was to determine the limit of sensitivity of detection of amine bloom using the methods described hereinabove by limiting the exposure of the samples during curing to amine bloom-producing conditions.

In FIG. 5F, the reflected powers measured at zero exposure time represent samples that were cured normally in the laboratory environment (22.5° C., 15% RH) and were not exposed to the adverse curing conditions. From the data in FIG. 5F, it is clear that the reflectivity of the samples decreased significantly within about one half-day (15 hours) of exposure to adverse conditions and remained low for all samples exposed to the adverse conditions for longer times. These data establish that low reflectivity is a good indicator of the presence of amine bloom for these epoxy paints. These data show conclusively that the effect of low temperature and high relative humidity environments on reflectivity is immediate and can be detected within one half day of exposure to adverse conditions. These results indicate that the formation of amine bloom in these epoxy paints occurs rapidly under adverse curing conditions.

FIG. 5G is a graph illustrating additional measurements used to examine the sensitivity of the method described above for detecting amine bloom in circumstances of extremely short periods of time after application of the epoxy paints. Reflected power measurements were performed on nine Sherwin-Williams black and yellow epoxy paint samples of the same varieties as described hereinabove. The samples were exposed to low temperature (10° C.) and high RH (90%) (adverse curing conditions) for different times following mixing of the resin and hardener. The nine samples were all placed in an environmental chamber after mixing according to the manufacturer's directions, and samples were removed one at a time at one hour intervals. The goal, as in the case of the data of FIG. 5F, was to determine the limit of the amine bloom detection method described above by limiting the exposure of the samples during cure to amine bloom production conditions

The reflected power measurement results in FIG. 5G illustrate that the reflectivity of the samples decreased significantly within one hour of exposure to the adverse conditions and remained low for all of the samples exposed for longer periods of time to the adverse conditions. Thus, these data, like the data in FIG. 5F, establish that the effect of low temperature and high humidity environments on reflectivity is relatively immediate and can be detected within one hour of exposure. Moreover, the ability to detect the presence of amine bloom in essentially real-time can allow remedial actions to be taken while a surface is being painted.

The method described above for amine bloom detection was compared with the method currently used by the Navy. In the method used by the U.S. Navy currently, the presence of amine bloom is indicated by a color change observed on an indicator test paper. The procedure currently used by the Navy is the following:
Use a white filter paper (clean, dry ˜1 sq in)
Obtain a solution of sodium-1,2-naphthoquinone-4-sulfonate in 50% ethanol/50% distilled water by weight, 1.6 grams/liter at 77 deg F.
Saturate filter paper (use tongs) in solution, place on painted surface, allow to remain 1 minute, remove and compare to piece of filter paper saturated and left to dry in ambient air away from any contamination
Visually inspect side of paper applied to paint, appositive response of amine is signified by a purple stain on filter paper.

A purple color change on the yellow treated indicator paper was observed for both the yellow and black paint samples that were cured in the low temperature, high RH conditions, indicating the presence of amine bloom. In contrast, the normally cured samples yielded indicator papers with no color change, indicating the absence of amine bloom. For reference, an indicator paper that was not used in a test was examined and closely resembled the papers used to test the normally cured samples. These indicator paper results showed conclusively that the epoxy paint samples cured under adverse conditions as described above produced detectable amine bloom. Furthermore, these results confirmed that the reflectance measurements described hereinabove were able to accurately detect amine bloom.

Table II summarizes some results of the comparison between the reflected light intensity method described above and the results from the method currently used by the Navy, in which color changes on indicator test papers are observed.

TABLE II
Comparison of Methods for Detection of Amine Bloom.

| | Test Results | | | |
|---|---|---|---|---|
| | Reflectance | | Indicator Paper | |
| Exposure (h) | Yellow | Black | Yellow | Black |
| 0 | normal | normal | normal | normal |
| 1 | amine bloom | amine bloom | amine bloom | amine bloom |
| 9 | amine bloom | amine bloom | amine bloom | amine bloom |
| 15 | amine bloom | amine bloom | amine bloom | amine bloom |

The reflectivity results were, without exception, consistent with the indicator paper results for both black (Sherwin-Williams DTRC 2844-1109) and yellow (Sherwin-Williams DTRC 2844-1110) epoxy paint samples. Identical results for amine bloom detection were obtained for normally cured (22.5° C., 15% RH) black and yellow samples and for the black and yellow paint samples cured for 1, 9, and 15 hours, respectively, under low temperature (10° C.) and high relative humidity (90%) conditions.

One observed aspect of amine bloom contamination was that once formed during the curing process, amine bloom was permanent. This conclusion follows because the samples compared in Table II were prepared roughly 7 months prior to obtaining the comparison results shown in Table II. In particular, after exposure to low temperature and high relative humidity conditions for specified periods of time (1 hour to 7 days), the samples were stored for over six months under normal laboratory conditions. Clearly, the epoxy curing reactions that occur under adverse environmental conditions that give rise to the amine bloom are irreversible. Therefore, once amine bloom is detected on a test surface, the contaminated paint must be removed, and fresh paint should be applied.

Reflectance measurements were also performed on an epoxy paint samples provided by the Navy. These samples consisted of 12 black and 12 yellow epoxy paint coated steel plates (4″×6″×0.031″ thick). Although the curing history of these samples was unknown at the time of measurement, the curing history information listed in Table III was subsequently obtained.

TABLE III
Navy epoxy paint sample information.

| Sample | Description | Paint | Application |
|---|---|---|---|
| 1 | 21 Jun. 2013 DTRC 2844 | 1110 | Roller |
| 2 | 21 Jun. 2013 DTRC 2844 | 1109 | Roller |
| 3 | 21 Jun. 2013 DTRC 2844 | 1110 | Sprayed 8% Thinned |
| 4 | 25 Jun. 2013 DTRC 2844 | 1109 | Sprayed 8% Thinned |
| 5 | 21 Jun. 2013 DTRC 2844 | 1110 | Sprayed 16% Thinned |
| 6 | 27 Jun. 2013 DTRC 2844 | 1109 | Sprayed 16% Thinned |
| 7 | 25 Jun. 2013 DTRC 2844 | 1110 | Roller |
| 8 | 25 Jun. 2013 DTRC 2844 | 1109 | Roller |
| 9 | 25 Jun. 2013 DTRC 2844 | 1110 | Sprayed 8% Thinned |
| 10 | 25 Jun. 2013 DTRC 2844 | 1109 | Sprayed 8% Thinned |
| 11 | 25 Jun. 2013 DTRC 2844 | 1110 | Sprayed 16% Thinned |
| 12 | 25 Jun. 2013 DTRC 2844 | 1109 | Sprayed 16% Thinned |
| 13 | 28 Jun. 2013 DTRC 2844 | 1110 | Roller |
| 14 | 28 Jun. 2013 DTRC 2844 | 1109 | Roller |
| 15 | 28 Jun. 2013 DTRC 2844 | 1110 | Sprayed 8% Thinned |
| 16 | 28 Jun. 2013 DTRC 2844 | 1109 | Sprayed 8% Thinned |
| 17 | 28 Jun. 2013 DTRC 2844 | 1110 | Sprayed 16% Thinned |
| 18 | 28 Jun. 2013 DTRC 2844 | 1109 | Sprayed 16% Thinned |
| 19 | 29 Jun. 2013 DTRC 2844 | 1110 | Roller |
| 20 | 29 Jun. 2013 DTRC 2844 | 1109 | Roller |
| 21 | 29 Jun. 2013 DTRC 2844 | 1110 | Sprayed 8% Thinned |
| 22 | 29 Jun. 2013 DTRC 2844 | 1109 | Sprayed 8% Thinned |
| 23 | 29 Jun. 2013 DTRC 2844 | 1110 | Sprayed 16% Thinned |
| 24 | 29 Jun. 2013 DTRC 2844 | 1109 | Sprayed 16% Thinned |

The apparatus used for the measurements listed in Table III was the same as the apparatus described previously in conjunction with FIG. 5A. In particular, the intensity of a chopped 12 mm diameter laser beam (785 nm, 4.6 mW) specularly reflected off of the surface of each epoxy paint sample was measured using the photodiode 502 in FIG. 5A. The laser beam was chopped at 23 Hz and the peak-to-peak photodiode output voltage was recorded using a digital oscilloscope.

FIG. 5H illustrates results from the reflectance measurements of the 24 epoxy paint samples provided by the Navy and listed in Table III. In FIG. 5H, the measured reflectance is plotted along the vertical axis, and the sample number is listed along the horizontal axis. The horizontal axis in FIG. 5H is segmented into four groups according to the date listed on the sample label of each sample, which is also listed in the Description column of Table III. The measured data in FIG. 5H show that samples 1, 2, 3, and 5, as well as possibly sample 6, had sufficiently high reflectance that these samples were amine bloom free. Sample 4 in FIG. 5H shows a particularly low reflectance, indicating the presence of amine bloom. From the measurement data in FIG. 5H, all of the other samples (7-24) show low reflectance, indicating the presence of amine bloom. Without detailed information regarding the preparation and curing procedures used for these samples, a “level” or degree of amine bloom contamination could not be assigned to the samples at the time of measurement with confidence. The measurements for samples 4 and 6 are marked with an X in FIG. 5H. As shown in Table III, samples 4 and 6, prepared 25 Jun. 2013 and 27 Jun. 2013, were dated out of sequence with the other samples for this blind test of the Navy samples. These two samples were possibly cured separately from the other samples.

Based on previous experience that amine bloom contaminated epoxy paint surfaces reflected significantly less 785 nm laser light, and with no prior knowledge of the sample preparation or curing protocols used for the samples, it was predicted that samples 1, 2, 3, 5, and 6 were amine bloom free and that the remainder of the samples were contaminated to some extent with amine bloom.

Subsequent to performing the reflectance measurements, the procedures used to prepare the 24 samples provided by the Navy were received. It was clear that the reflectance measurements successfully detected the presence and absence of amine bloom for all 24 epoxy paint samples prepared by the Navy. The sample information and the sample preparation conditions subsequently received from the Navy are shown in Table IV.

TABLE IV
Navy epoxy paint sample information
and sample preparation conditions.

| Sample | Description | Paint | Application |
|---|---|---|---|
| 1 | 21 Jun. 2013 DTRC 2844 | 1110 | Roller |
| 2 | 21 Jun. 2013 DTRC 2844 | 1109 | Roller |
| 3 | 21 Jun. 2013 DTRC 2844 | 1110 | Sprayed 8% Thinned |
| 4 | 25 Jun. 2013 DTRC 2844 | 1109 | Sprayed 8% Thinned |
| 5 | 21 Jun. 2013 DTRC 2844 | 1110 | Sprayed 16% Thinned |
| 6 | 27 Jun. 2013 DTRC 2844 | 1109 | Sprayed 16% Thinned |
| 7 | 25 Jun. 2013 DTRC 2844 | 1110 | Roller |
| 8 | 25 Jun. 2013 DTRC 2844 | 1109 | Roller |
| 9 | 25 Jun. 2013 DTRC 2844 | 1110 | Sprayed 8% Thinned |
| 10 | 25 Jun. 2013 DTRC 2844 | 1109 | Sprayed 8% Thinned |
| 11 | 25 Jun. 2013 DTRC 2844 | 1110 | Sprayed 16% Thinned |
| 12 | 25 Jun. 2013 DTRC 2844 | 1109 | Sprayed 16% Thinned |
| 13 | 28 Jun. 2013 DTRC 2844 | 1110 | Roller |
| 14 | 28 Jun. 2013 DTRC 2844 | 1109 | Roller |
| 15 | 28 Jun. 2013 DTRC 2844 | 1110 | Sprayed 8% Thinned |
| 16 | 28 Jun. 2013 DTRC 2844 | 1109 | Sprayed 8% Thinned |
| 17 | 28 Jun. 2013 DTRC 2844 | 1110 | Sprayed 16% Thinned |
| 18 | 28 Jun. 2013 DTRC 2844 | 1109 | Sprayed 16% Thinned |
| 19 | 29 Jun. 2013 DTRC 2844 | 1110 | Roller |
| 20 | 29 Jun. 2013 DTRC 2844 | 1109 | Roller |
| 21 | 29 Jun. 2013 DTRC 2844 | 1110 | Sprayed 8% Thinned |
| 22 | 29 Jun. 2013 DTRC 2844 | 1109 | Sprayed 8% Thinned |
| 23 | 29 Jun. 2013 DTRC 2844 | 1110 | Sprayed 16% Thinned |
| 24 | 29 Jun. 2013 DTRC 2844 | 1109 | Sprayed 16% Thinned |

June 21-No amine bloom conditions
Inductive 60 min
Material temp [symbol] 75 F.
Cure temp [symbol] 95 F.
Cure humidity: [symbol]
Atmospheric conditions in spray booth: 70 F., 60 RH
June 25-Lowest amine bloom conditions (“Medium-Low” name
in test plan)
Inductive 50 min
Material temp [symbol] 65 F.
Cure Temp. 65 F.
Cure humidity: 65 [symbol]
Atmospheric conditions in spray booth: 70 F., 60 RH
June 28-Medium arrive bloom conditions (“Medium-High” name
in test plan)
Inductive 20 min
Material temp [symbol] 60 F.
Cure Temp [symbol] 60 F.
Cure humidity: 85 [symbol]
Atmospheric conditions in spray booth: (“High” name in test plan)
June 29-Highest amine bloom conditions (“High” name in test plan)
Inductive 10 min
Material temp [symbol] 60 F.
Cure Temp [symbol] 56 F.
Cure humidity: [symbol]
Atmospheric condition in spray booth: 70 F., 50 RH
June 27 (redo of the June 21 condition) No amine bloom
Only for 1109 Sprayed both with 8% and 16% thinning
Atmospheric conditions in spray booth: 70 F., 60 RH [symbol]
indicates data missing or illegible when filed

The sample preparation conditions listed in Table IV confirm that the predictions based on the reflectance measurements described above were 100% accurate.

While this invention has been particularly shown and described with references to example embodiments thereof, it will be understood by those skilled in the art that various changes in form and details may be made therein without departing from the scope of the invention encompassed by the appended claims.

What is claimed is:

1. A device comprising:
an optical detector configured to detect a specular reflection from a test article having a coating thereon; and
a processor operatively coupled to the optical detector and configured to determine whether a contaminant is present at the coating based on the specular reflection and a calibration measurement determined from a calibration article having a known contaminant-free sample of the coating thereon.

2. The device of claim 1, wherein the coating is an epoxy coating and the contaminant is amine bloom.

3. The device of claim 1, wherein the coating is a paint coating.

4. The device of claim 1, wherein the optical detector and the processor form part of a handheld device.

5. The device of claim 1, wherein the processor is configured to determine whether the contaminant is present in the coating.

6. The device of claim 1, wherein the calibration measurement determined from the calibration article is obtained environmentally proximal to the specular reflection from the test article.

7. The device of claim 1, wherein the specular reflection is a near-infrared (IR) reflection.

8. The device of claim 1, wherein the specular reflection is a mid-IR or visible reflection.

9. The device of claim 1, further comprising an LED or laser source configured to output a collimated beam, wherein the specular reflection from the surface is a reflection of the collimated beam.

10. The device of claim 1, wherein the specular reflection from the test article is at an angle of less than 20 degrees with respect to an axis normal to the test article.

11. The device of claim 10, wherein the specular reflection is substantially collinear with the axis normal to the test article.

12. The device of claim 1, wherein the test article is a boat, ship, submarine, bridge, oil well, or oil platform with a surface having the coating thereon.

13. The device of claim 1, wherein the processor is configured to use the calibration measurement to correct for an effect of temperature or humidity.

14. A device comprising:
an optical detector configured to detect a specular reflection from a test article having a coating thereon, the specular reflection at an angle of less than 20 degrees with respect to an axis normal to the test article; and
a processor configured to determine whether contamination is present at the coating based on the specular reflection.

15. The device of claim 14, wherein the specular reflection is substantially collinear with the axis normal to the test article.

16. The device of claim 14, wherein the processor is further configured to determine whether the contamination is present based further on a calibration measurement determined from a calibration article having a known contaminant-free sample of the coating thereon.

17. The device of claim 14, further comprising a device housing configured to hold the optical detector and the processor, the housing further configured to be held in a human hand.

18. The device of claim 14, further comprising an LED or laser source configured to output a collimated beam, and wherein the specular reflection from the test article is a reflection of the collimated beam.

19. A contamination tester comprising:
a housing with a front housing surface configured to be placed substantially parallel and proximal to a contamination test surface;
a flexible gasket surrounding an optical port on the front housing surface; and
three or more substantially rigid contact pads on the front housing surface, the contact pads configured to come into contact with the test surface to register the front housing surface substantially parallel to the test surface with the flexible gasket forming a light-restrictive seal with the test surface.

20. The contamination tester of claim 19, further comprising a contact switch configured to change its switch state as the contact pads are brought into and out of contact with the test surface, a switch ON state arming or activating the contamination tester and a switch OFF state disarming or inactivating the contamination tester.

21. The contamination tester of claim 20, wherein the contact switch is configured to arm the contamination tester to enable a trigger switch to trigger a contamination measurement of the test surface.

22. The contamination tester of claim 20, wherein the flexible gasket protrudes a first distance from the front housing surface when not contacting the test surface, wherein the contact pads protrude a second distance from the front housing surface, the second distance being less than the first distance, and wherein the contact switch protrudes a third distance from the front housing surface, the third distance being between the first and second distances.

23. The contamination tester of claim 19, wherein the flexible gasket is configured to flex as the gasket is pushed against the test surface to allow the contact pads to come into contact with the test surface.
